(19) United States
(12) Patent Application Publication
(10) Pub. No.: US 2011/0210715 A1
(43) Pub. Date: Sep. 1, 2011

(54) Error Compensating Method for Instrument Transformer

(76) Inventors: Yong Kyun Kim, Seoul (KR); Yong Cheol Kang, Jeollabuk-do (KR); Sung Il Jang, Jeollabuk-do (KR)

(21) Appl. No.: 11/991,607

(22) PCT Filed: Jul. 27, 2006
(86) PCT No.: PCT/KR2006/002954

§ 371 Date: Aug. 11, 2009

(30) Foreign Application Priority Data
Aug. 9, 2005 (KR) 10-2005-0073002

(51) Int. Cl. H01F 38/28

(52) U.S. Cl. 323/357

(57) ABSTRACT

Provided an error compensating method for an instrument transformer, in which an error of an instrument transformer is compensated by reflecting hysteresis characteristics of iron core. When such error compensation is performed, a hysteresis loop indicating the relationship between magnetic flux and excitation current is not used as it is, but core-loss resistances and magnetic flux-excitation current curves are used, thereby achieving more precise compensation. According to the present invention, an error of an instrument transformer can be significantly reduced. Therefore, it is possible to manufacture an instrument transformer with high accuracy and to significantly reduce the size of the instrument transformer. Further, a material with high permeability does not need to be used in order to increase the accuracy.

### TECHNICAL FIELD

The present invention relates to an error compensating method for an instrument transformer. In the error compensating method, an error of an instrument transformer is compensated by reflecting hysteresis characteristics of iron core. When such error compensation is performed, a hysteresis loop indicating the relationship between magnetic flux and excitation current is not used as it is, but core-loss resistances and magnetic flux-excitation current curves are used, thereby achieving more precise compensation.

### BACKGROUND ART

In order to measure voltages and currents flowing in various electric equipments such as generators, power-transmission lines, transformers and the like, an instrument transformer is used. As for the instrument transformer, there are provided a voltage transformer for measuring a voltage and a current transformer for measuring a current. Depending on the use, the instrument transformer is divided into an instrument transformer for protection and an instrument transformer for measurement.

As for the current transformer, there are provided an iron-core current transformer using iron, an air-core current transformer using an air core, and an air-gap current transformer using an iron core with an air gap, depending on a material of core. Depending on the structure, the current transformer is divided into a wire-wound current transformer and a bushing-type current transformer. In the case of the voltage transformer, iron is used as a core, and there is provided only a wire-wound voltage transformer.

In the instrument transformer, only the magnitude of a primary voltage or current should be reduced. However, an error is always present due to a material or structure of core. The cause of error in the instrument transformer will be examined by using a simple equivalent circuit of the instrument transformer.

FIGS. 1 and 3 illustrate a simple equivalent circuit in which a bushing-type current transformer, a wire-wound current transformer, and a voltage transformer are converted into the secondary side. In the drawings, R₁, Lₘ, and R represent primary wire-wound resistance converted into the secondary side, magnetizing inductance, and secondary resistance, respectively. Further, v₁ represents a primary voltage converted into the secondary side, v₂ represents a secondary voltage, i₁ represents a primary current converted into the secondary side, i₂ represents a secondary current, and iₘ represents a magnetizing current.

In general, it can be said that an error of the instrument transformer is caused by the magnetizing inductance Lₘ. That is, if Lₘ is small, iₘ increases. Therefore, a difference (error) between i₁ and i₂ increases in the case of a current transformer, and an error in ratio of transmission, which is a difference between v₁ and v₂, increases in the case of a voltage transformer. Accordingly, in order to increase the accuracy of a current transformer and a voltage transformer, wLₘ22 >R should be established.

The magnetizing inductance Lₘ can be represented by the following expression (1).

$${L}_{m} = \frac{{μ}_{o} {μ}_{r} {AN}^{2}}{l} \qquad ( 1 )$$

Here, μₒ, μᵣ, A, N, and 1 represent permeability of the air, permeability of a medium, a sectional area of core, the number of wire turns, and a length of magnetic path of core, respectively.

Conventionally, an instrument transformer with high accuracy has been manufactured by increasing Lₘ. For this, the following method has been used.

1) Increase a sectional area of core.

2) Use a medium with excellent permeability.

3) Increase the number of wire turns.

4) Reduce the length of a magnetic path.

That is, as a general solution for increasing the accuracy of an instrument trans former, a sectional area of core is increased, the number of wire turns is increased, or a core formed of a material with high permeability is used. In this case, however, the size of the instrument transformer increases, and a cost increases.

As another attempt for improving the accuracy of a current transformer, there is provided a method in which an excitation current is estimated by using hysteresis loops of FIG. 4 indicating the relationship between magnetic flux and excitation current in order to compensate an error, considering that an error of a current transformer is caused by an excitation current. That is, compensation is performed by estimating an excitation current from hysteresis curves, thereby obtaining an accurate primary current. Therefore, it is possible to improve the accuracy.

In this method, however, a very large number of hysteresis loops should be previously measured and stored in a memory, because the compensation is performed by using the hysteresis loops as they are. Further, there occur many errors in performing interpolation between two adjacent hysteresis curves. Particularly, when a magnetic flux is large, there is a limit in improving the accuracy of a current transformer, because an interpolation error increases.

In another method, the largest loop (main loop) among a plurality of hysteresis loops is used so that compensation is performed in accordance with the magnitude of magnetic flux. In this method, when a current is large, the accuracy is improved because a hysteresis characteristic coincides with the main loop to some degree. However, when a current decreases, a hysteresis characteristic does not coincide with the main loop. Therefore, there is a limit in improving the accuracy.

In two of the above-described methods, when a direct current component is included in a current, an error increases because a hysteresis characteristic differs. Further, when a harmonic component is present in a current such that increase and decrease are repeated, an error also increases.

### DISCLOSURE OF INVENTION

### Technical Problem

An advantage of the present invention is that it provides an error compensating method for an instrument transformer. In the error compensating method, hysteresis characteristics of iron core are used for compensating an error. In this case, a hysteresis loop indicating the relationship between magnetic flux and excitation current is not used as it is, but core-loss resistances and magnetic flux-excitation current curves are used. Therefore, interpolation is easily and precisely performed, so that precise compensation can be performed at a current, which is much smaller than a rated current, as well as at a rated current.

### Technical Solution

According to an aspect of the invention, an error compensating method for an instrument transformer comprises receiving a secondary current at a predetermined interval; calculating a magnetic flux from the secondary current; selecting core-loss resistance and relational information between magnetic flux and magnetizing current, which correspond to the calculated magnetic flux, from a plurality of core-loss resistances and relational information between magnetic flux and magnetizing current which are obtained from hysteresis characteristics of iron core; obtaining a core-loss current by using the selected core-loss resistances; and obtaining a magnetizing current with respect to the calculated magnetic flux from the selected relational information between magnetic flux and magnetizing current and adding the obtained magnetizing current to the obtained core-loss current and the received secondary current so as to calculate a primary current.

According to another aspect of the invention, an error compensating method for an instrument transformer comprises receiving a secondary voltage at a predetermined interval and obtaining a secondary current with respect to the secondary voltage; calculating a magnetic flux from the secondary voltage; selecting core-loss resistance and relational information between magnetic flux and magnetizing current, which correspond to the calculated magnetic flux, from a plurality of core-loss resistances and relational information between magnetic flux and magnetizing current which are obtained from hysteresis characteristics of iron core; obtaining a core-loss current by using the selected core-loss resistances; obtaining a magnetizing current with respect to the calculated magnetic flux from the selected relational information between magnetic flux and magnetizing current and adding the obtained magnetizing current to the obtained core-loss current and the obtained secondary current so as to calculate a primary current; and calculating a primary voltage by using the obtained primary current and the received secondary voltage.

According to a further aspect of the invention, the obtaining of the plurality of core-loss resistances and the relational information between magnetic flux and magnetizing current through measurement includes obtaining core-loss resistance from one measured magnetic flux-excitation current curve; obtaining a core-loss current by using the obtained core-loss resistance; obtaining a magnetic flux-magnetizing current curve from the obtained core-loss current and the measured magnetic flux-excitation current curve; and repeating the above processes on different measured magnetic flux-excitation current curves so as to obtain a plurality of core-loss resistances and a plurality of magnetic flux-magnetizing current curves.

### Advantageous Effects

According to the present invention, an error of an instrument transformer can be significantly reduced. Therefore, an instrument transformer with high accuracy can be manufactured, and the size thereof can be significantly reduced.

Further, an error of an instrument transformer is compensated by using hysteresis characteristics of iron core. When such error compensation is performed, a hysteresis loop indicating the relationship between magnetic flux and excitation current is not used as it is, but core-loss resistances and magnetic flux-excitation current curves are used, thereby achieving precise compensation on a wider range of current.

Further, in the hysteresis loop, there is a limit in improving the accuracy, because it is difficult to perform interpolation. However, when the core-loss resistances and the λ-iₘ functions are used, interpolation can be easily performed, and the number of functions required for interpolation is significantly reduced.

### BRIEF DESCRIPTION OF THE DRAWINGS

FIG. 1 is a diagram showing a simple equivalent circuit of a conventional bushing-type current transformer.

FIG. 2 is a diagram showing a simple equivalent circuit of a conventional wire-wound current transformer.

FIG. 3 is a diagram showing a simple equivalent circuit of a conventional voltage transformer.

FIG. 4 is a diagram showing hysteresis characteristics of iron core.

FIG. 5 is a diagram showing an equivalent circuit of a bushing-type current transformer in which hysteresis characteristics are considered.

FIG. 6 is a diagram illustrating a magnetic flux-excitation current curve and a magnetic flux-magnetizing current curve.

FIG. 7 is a diagram illustrating a group of magnetic flux-magnetizing current (λ-iₘ) curves.

FIG. 8 is an extended view of FIG. 7.

FIGS. 9 and 10 show compensation results of the invention.

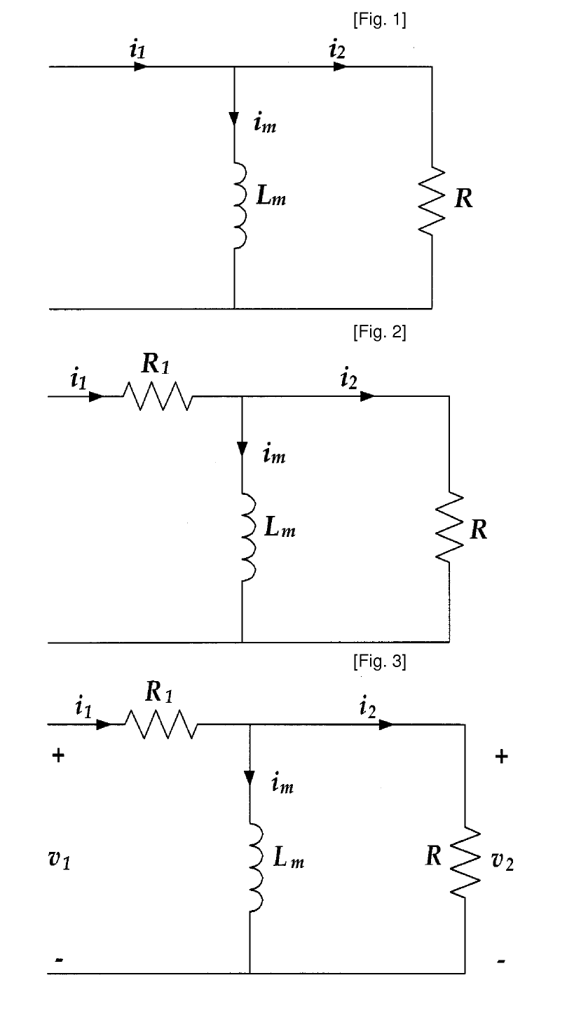

### REFERENCE NUMERALS

R₁ primary wire-wound resistance
Lₘ magnetizing inductance
R secondary wire-wound resistance
R_{c} core-loss resistance
v₁ primary voltage converted into secondary side
v₂ secondary voltage
i₁ primary current converted into secondary side
i₂ secondary current
i₀ excitation current
i_{c} core-loss current
iₘ magnetizing current

### BEST MODE FOR CARRYING OUT THE INVENTION

Hereinafter, an error compensation method of an instrument transformer according to the present invention will be described in detail with reference to the accompanying drawings. In this case, an iron-core current transformer will be exemplified.

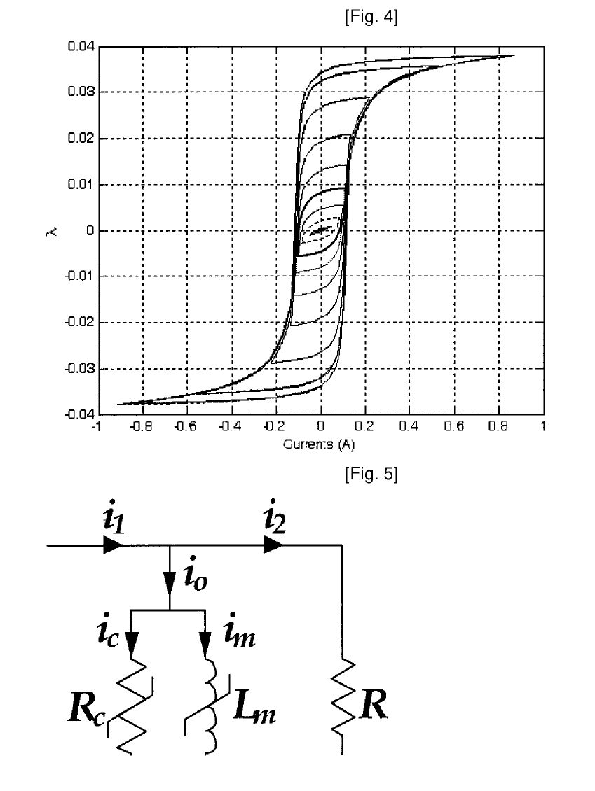

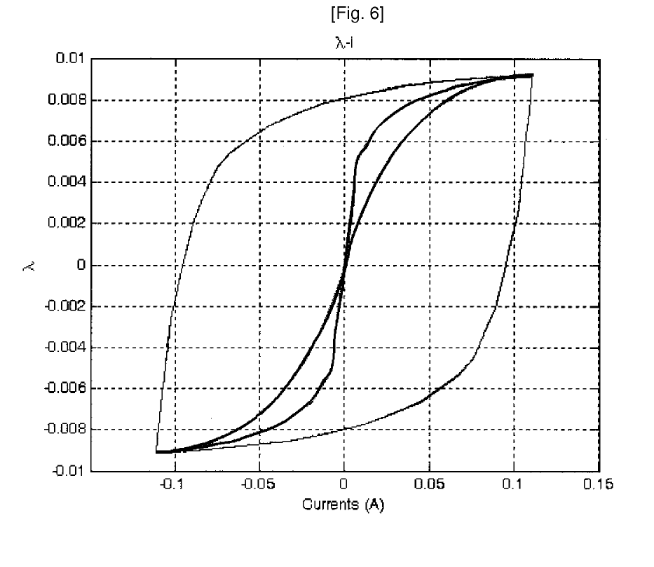

FIG. 5 is a diagram showing an equivalent circuit of a current transformer in which hysteresis characteristics of iron core are considered. Here, R_{c} and Lₘ represent core-loss resistance and magnetizing inductance, respectively, both of which have non-linear characteristics. Further, i₀, i_{c}, and iₘ represent an excitation current, a core-loss current, and a magnetizing current, respectively, among which the relationship of i₀=i_{c}+iₘ is established.
The hysteresis characteristics of iron core are represented by a curve showing the relationship between magnetic flux and excitation current (λ-i₀). FIG. 6 shows a hysteresis curve selected from the plurality of hysteresis curves of FIG. 4 (refer to the outer curve of two curves of FIG. 6).

In FIG. 6, an internal area surrounded by the hysteresis curve is constant. Therefore, the core-loss resistance R_{c} is a constant, which can be obtained by an experiment and the like. Further, since i_{c} is a current flowing in R_{c}, i_{c} can be obtained by using an expression (2).

i_{c}=v₂/R_{c} (2)

Here, v₂ represents a secondary voltage, which can be obtained by using v₂=Ri₂.

Since iₘ is obtained by subtracting a core-loss current from an excitation current, it can be obtained by iₘ=i₀−iₓ. A λ-iₘ curve is obtained from iₘ and λ and is shown in FIG. 6 (the inner curve of two curves).

The λ-iₘ curve of FIG. 6 represents the relationship between λ and iₘ. Therefore, if the magnetic flux λ is known, iₘ corresponding to λ can be obtained from the λ-iₘ curve.

Here, λ can be obtained as follows. In the circuit of FIG. 5, the following relationship is established.

$${v}_{2} = {Ri}_{2} = \frac{d λ}{d t} \qquad ( 3 )$$

Therefore, if both members are integrated, the following equation is obtained.

$$λ ( t ) - λ ( {t}_{0} ) = R {\int }_{{t}_{0}}^{t} {i}_{2} d t \qquad ( 4 )$$

Here, λ(t₀) is an initial magnetic flux and can be obtained by using such a characteristic that an average value of λ(t) during one period is 0.

As described above, i_{c} is obtained from R_{c} by using one hysteresis curve, and the λ-iₘ curve is obtained therefrom. Further, if iₘ corresponding to λ is obtained from the λ-iₘ curve, an excitation current can be estimated by adding i_{c} to iₘ. Therefore, an accurate primary current can be obtained from the excitation current and a secondary current.

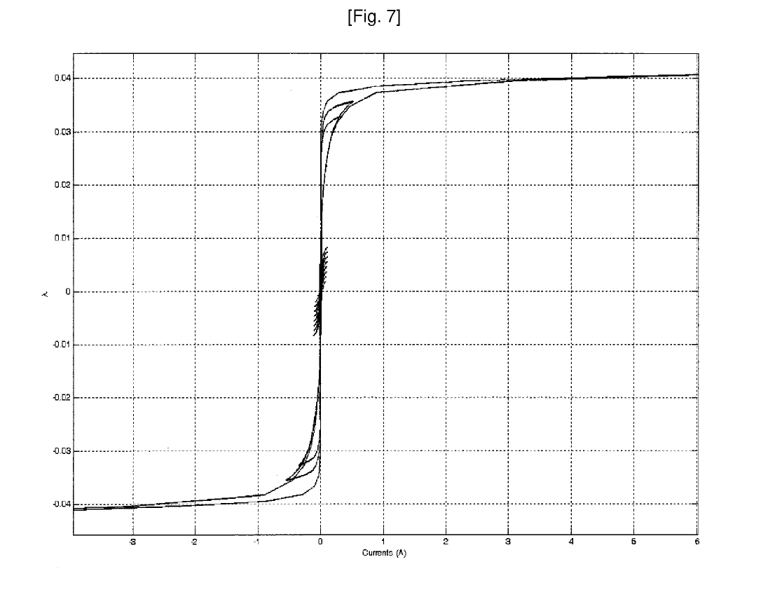

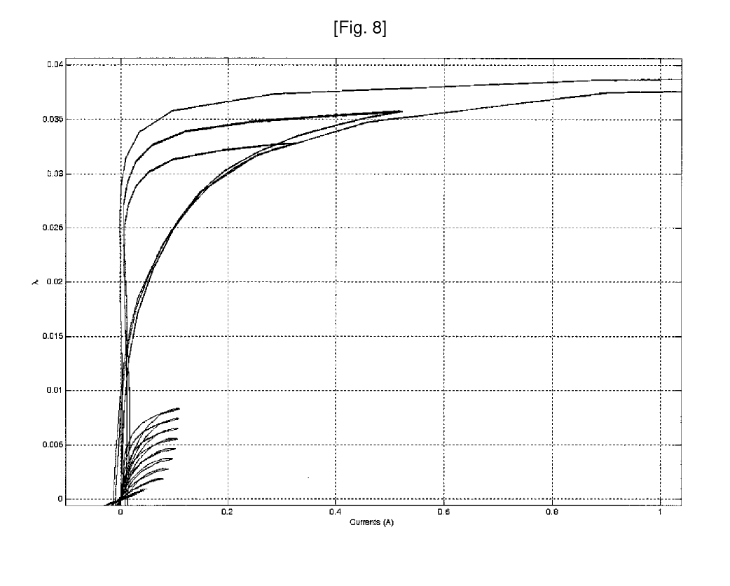

FIG. 7 shows λ-iₘ curves obtained from the plurality of λ-i₀ curves of FIG. 4 through the above-described process. FIG. 8 is an extended diagram showing the upper half of FIG. 7.

From the variety of hysteresis curves, R with respect to the respective curves can be obtained, and λ-iₘ curves can be drawn. Further, in a case of a hysteresis curve which is not measured, R_{c} is estimated by interpolation, and λ-iₘ may be also interpolated. Such interpolation can be performed in a process, where basic information to be previously provided to an instrument transformer is obtained, or can be performed in an actual compensation process of an instrument transformer.

In a compensation step, a magnetic flux during a predetermined period is measured (or calculated), and a λ-iₘ curve corresponding to each interval in which the measured magnetic flux is included is selected (selection of operating point), so that compensation is performed along the curve. Alternately, a new λ-iₘ curve is obtained from the selected λ-iₘ Curves, and required information is obtained therefrom such that compensation is performed.

Meanwhile, such a method, in which the interpolation is performed with R_{c} and λ-iₘ being separated, is more convenient and more precise than a method of interpolating λ-i₀.

That is, when the respective loops (curves) of FIG. 8 are divided into two intervals (an interval in which a magnetic flux is large and an interval in which a magnetic flux is small), the loop at the interval in which a magnetic flux is small can be approximated to one straight line or curve function. Further, at the interval in which a magnetic flux is large, the curve is formed in a loop shape. In this case, however, when a current increases, the curve functions can be approximated to one curve function. Only when a current decreases, the plurality of curve functions are needed. Further, in a case where the curve functions cannot be approximated to one curve function when a current increases, one curve function for each loop is needed as in the case where a current decreases. Even in this case, at least in the interval in which a magnetic flux is small, more convenient approximation can be achieved by one function.

An advantage of such approximation become distinct, compared with when interpolation is performed by using a hysteresis curve as it is.

When interpolation is performed by using a hysteresis curve, the pattern thereof is not fixed depending on an operating point. Therefore, it is difficult to find an interpolation function, so that there is a limit in enhancing the accuracy. In the present invention, however, the interpolation of core-loss resistance and the interpolation between magnetic flux and excitation current are easily performed. Therefore, it is possible to significantly improve the accuracy.

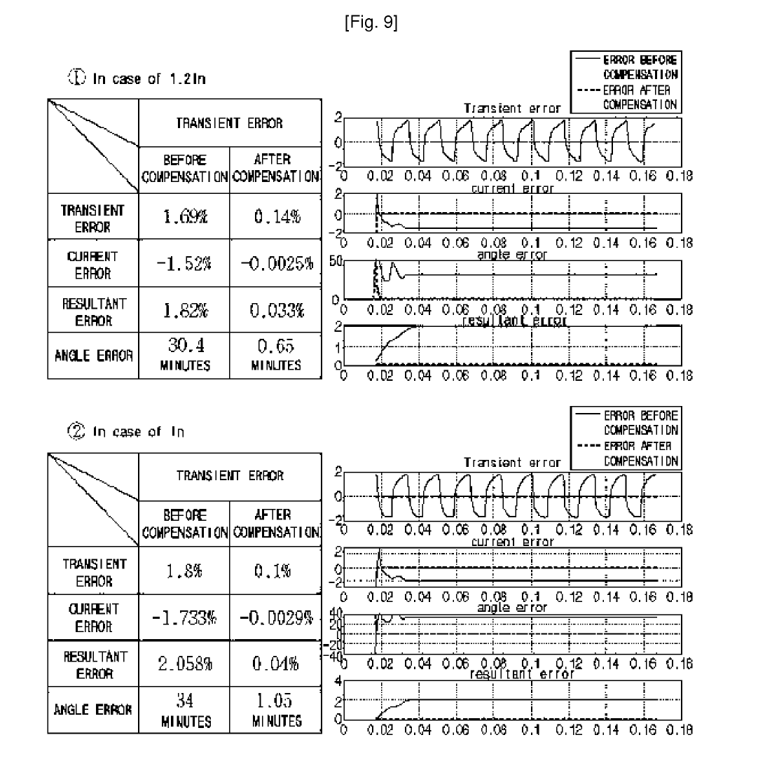

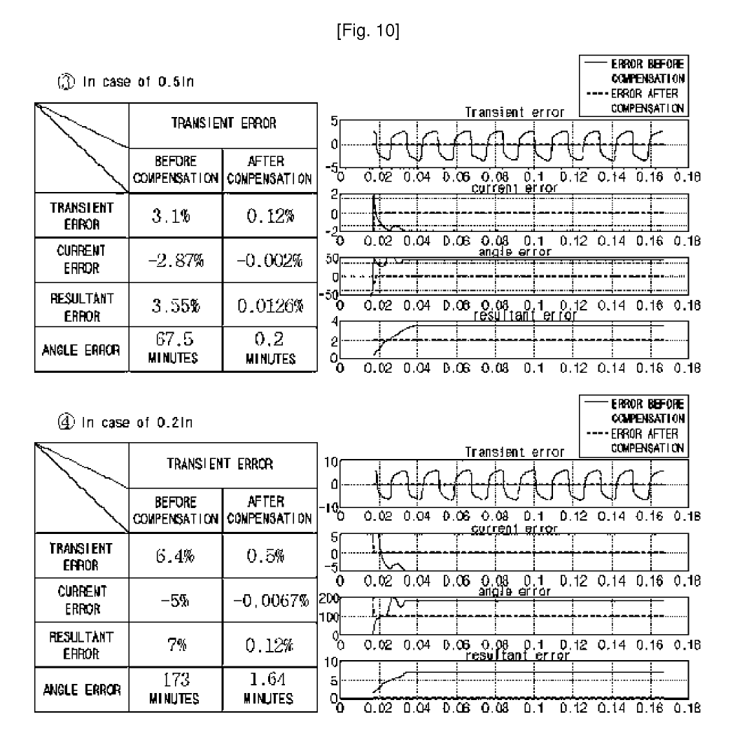

FIGS. 9 and 10 comparatively show compensation results in various cases of 1.2In, In, 0.5In, 0.2In, 0.1In, and 0.05In (In means a rated current) in the compensating method of the invention. In this case, a current ratio is 200:5, a secondary burden is 0.5Ω, and an overcurrent constant is 2. As shown in FIGS. 9 and 10, it can be found that various errors are significantly reduced in comparison with when compensation is not performed.

Although the iron-core transformer has been described so far, the error compensating method of the invention is also applied to an air-core current transformer or a voltage transformer.

In the case of the air-core current transformer, the application of the invention is simplified. That is, since core-loss resistance is 0 in the air-core transformer, a core-loss current does not need to be considered. Since the relationship between magnetic flux and excitation current (excitation current corresponds to a magnetizing current because a core-loss current is not present) is linear, only one straight line is used for compensation, instead of a plurality of λ-iₘ curves.

In the case of the voltage transformer, since the characteristics of iron core are shown in the voltage transformer except that a voltage is used instead of a current, the voltage transformer is dealt the same as the case of the iron-core current transformer. That is, a secondary current can be obtained from the relationship between secondary voltage and resistance (v₂=i₂R) in FIG. 3, and a primary current can be obtained by adding an excitation current and the secondary current (i₁=i₀+i₂) as in the iron-core current transformer. As such, after the primary current is obtained, v₁ is obtained from the relationship of v₁=i₁R₁+v₂.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents. For example, the compensating method of the present invention can be applied to various devices, such as a relay, a gauge, a measuring instrument, PMU, a circuit breaker and the like, which use a current or voltage. Therefore, the compensating method of the invention should be protected regardless of the types of devices to which the method is applied.

1. An error compensating method for an instrument transformer comprising:
receiving a secondary current at a predetermined interval;
calculating a magnetic flux from the secondary current;
selecting core-loss resistance and relational information between magnetic flux and magnetizing current, which correspond to the calculated magnetic flux, from a plurality of core-loss resistances and relational information between magnetic flux and magnetizing current which are obtained from hysteresis characteristics of iron core;
obtaining a core-loss current by using the selected core-loss resistances; and
obtaining a magnetizing current with respect to the calculated magnetic flux from the selected relational information between magnetic flux and magnetizing current and adding the obtained magnetizing current to the obtained core-loss current and the received secondary current so as to calculate a primary current.

2. An error compensating method for an instrument transformer comprising:
receiving a secondary voltage at a predetermined interval and obtaining a secondary current with respect to the secondary voltage;
calculating a magnetic flux from the secondary voltage;
selecting core-loss resistance and relational information between magnetic flux and magnetizing current, which correspond to the calculated magnetic flux, from a plurality of core-loss resistances and relational information between magnetic flux and magnetizing current which are obtained from hysteresis characteristics of iron core;
obtaining a core-loss current by using the selected core-loss resistances;
obtaining a magnetizing current with respect to the calculated magnetic flux from the selected relational information between magnetic flux and magnetizing current and adding the obtained magnetizing current to the obtained core-loss current and the obtained secondary current so as to calculate a primary current; and
calculating a primary voltage by using the obtained primary current and the received secondary voltage.

3. The error compensating method according to claim 1 or 2;
wherein some among the plurality of core-loss resistances and the relational information between magnetic flux and magnetizing current are obtained by measurement and the others are obtained by interpolation.

4. The error compensating method according to claim 3,
wherein the obtaining of the plurality of core-loss resistances and the relational information between magnetic flux and magnetizing current through measurement includes:
obtaining core-loss resistance from one measured magnetic flux-excitation current curve;
obtaining a core-loss current by using the obtained core-loss resistance;
obtaining a magnetic flux-magnetizing current curve from the obtained core-loss current and the measured magnetic flux-excitation current curve; and
repeating the above processes on different measured magnetic flux-excitation current curves so as to obtain a plurality of core-loss resistances and a plurality of magnetic flux-magnetizing current curves.

5. The error compensating method according to claim 4,
wherein the interpolation for obtaining the core-loss resistances and the relational information between magnetic flux and magnetizing current is performed in a state where a function is divided for each interval.

6. The error compensating method according to claim 5,
wherein the interval is divided into two intervals depending on the magnitude of magnetic flux, one function is present for each loop in the interval where a magnetic flux is small, and one function is present for each loop when a magnetizing current increases and when a magnetizing current decreases, respectively, in the interval where a magnetic flux is large.

7. The error compensating method according to claim 1 or 2,
wherein the obtaining of the plurality of core-loss resistances and the relational information between magnetic flux and magnetizing current includes:
obtaining core-loss resistance from one measured magnetic flux-excitation current curve;
obtaining a core-loss current by using the obtained core-loss resistance;
obtaining a magnetic flux-magnetizing current curve from the obtained core-loss current and the measured magnetic flux-excitation current curve; and
repeating the above processes on different measured magnetic flux-excitation current curves so as to obtain a plurality of core-loss resistances and a plurality of magnetic flux-magnetizing current curves.

8. The error compensating method according to claim 7 further comprising:
obtaining new core-loss resistance and new relational information between magnetic flux and magnetizing current from the selected core-loss resistance and the selected relational information between magnetic flux and magnetizing current between the obtaining of the magnetic flux-magnetizing current curve and the repeating of the above processes.

9. The error compensating method according to claim 8,
wherein, in the obtaining of new core-loss resistance and new relational information, interpolation is performed in a state where a function is divided for each interval.

10. The error compensating method according to claim 9,
wherein the interval is divided into two intervals depending on the magnitude of magnetic flux, one function is present for each loop in the interval where a magnetic flux is small, and one function is present for each loop when a magnetizing current increases and when a magnetizing current decreases, respectively, in the interval where a magnetic flux is large.

11. An error compensating method for an instrument transformer comprising:
receiving a secondary current at a predetermined interval;
calculating a magnetic current from the secondary current;
obtaining an excitation current corresponding to the calculated magnetic flux from linear relational information between magnetic flux and excitation current; and
adding the received secondary current to the obtained excitation current so as to calculate a primary current.
